(19) United States
(12) Patent Application Publication
(10) Pub. No.: US 2004/0057874 A1
(43) Pub. Date: Mar. 25, 2004

(54) Light-interference fluid characteristics analyzer and frame for such analyzer

(75) Inventor: Tomoo Ishiguro, Tokyo (JP)

Correspondence Address: CONNOLLY BOVE LODGE & HUTZ LLP, SUITE 800, 1990 M STREET NW, WASHINGTON, DC, 20036-3425, US

(73) Assignee: Riken Keiki Co., Ltd, Tokyo (JP)

(21) Appl. No.: 10/253,415

(22) Filed: Sep. 25, 2002

(51) Int. Cl. G01N 21/17

(52) U.S. Cl. 422/82.05; 422/104; 356/450

(57) ABSTRACT

A frame is formed by forming in a base having at least three through-holes 2, 3 and 4 in the same cross section cavities 6 and 7 crossing said through-holes 2 to 5 at a given distance. A cell is formed by sealing an area sandwiched by said two cavities 6 and 7 with translucent sheets 8 and 9. Interference fringes are generated by sending two beams from a light-source element 19 into the cell through as parallel plane mirror 14 and reflecting the beams from the cell to a single spot on the parallel plane mirror 14 through a prism 15.

### BACKGROUND OF THE INVENTION

1. Field of the Invention

This invention relates to an analyzer that detects difference of light refraction difference between a fluid to be analyzed and a reference fluid as a change in interference fringe and determines the calorific value, concentration and other characteristics of the fluid to be analyzed.

2. Prior Art

A light-interference fluid characteristics analyzer comprises, as, for example, described in Japanese Provisional Utility Model Publication No. 199056 of 1988, optical elements including a measuring cell, a reference cell, a light source, lenses, a parallel plane mirror constituting a beam splitter, prisms, and an interference fringe detector that are properly positioned with respect to the optical axis and bolted to the bottom of a casing.

As the amount of change in interference fringe caused by a change in fluid characteristics is extremely small, displacement of the elements greatly affects detection accuracy. Therefore, installation of elements requires skill and adds up cost of manufacture. The need to secure strength to insure that external forces do not displace the elements increases the thickness of the casing and the weight of the whole analyzer.

### SUMMARY OF THE INVENTION

A light-interference fluid characteristics analyzer according to this invention comprises a frame having at least three through-holes in the same cross section and cavities crossing the through-holes at a given distance. An area sandwiched between the two cavities is sealed by translucent sheets to form a cell. The frame also contains an optical means that sends two beams from a single light source into the cell through a beam splitter and forms an interference fringe by reflecting the beams from the cell to a single spot through a prism.

A frame for a light-interference fluid characteristics analyzer according to this invention, has at least three through-holes in the same cross section, cavities crossing the through-holes at a given distance, and a cavity to contain an optical means that forms an interference fringe by sending two beams from a single light source into an area sandwiched between said cavities.

### OBJECT AND EFFECT OF THE INVENTION

An object of this invention is to provide a light-interference fluid characteristics analyzer that permits easy installation of optical elements and weight reduction.

Another object of this invention is to provide a frame for a light-interference fluid characteristics analyzer.

This invention provides high rigidity by means of vertical and horizontal walls defining the through-holes and permits easy forming of the cavities to contain the translucent sheets and optical elements constituting the cell. Fitting the elements in the defining cavities permits elements installation with high accuracy.

### BRIEF DESCRIPTION OF THE DRAWINGS

FIG. 1 is an exploded perspective view of a light-interference fluid characteristics analyzer according to this invention.

FIG. 2 is a perspective view showing an example of the base material forming the frame of said analyzer.

FIGS. 3(a) and 3(b) show the parallel plane mirror and prism viewed from the bottom.

FIG. 4 schematically illustrates a light path formed by the frame.

FIGS. 5(a) and 5(b) show other embodiments of the frame having slits to fix lenses and cavities to hold the translucent sheets to form the cell in different positions.

FIGS. 6(a) and 6(b) are perspective views showing other embodiments of the frame according to this invention.

FIG. 7 is a cross-sectional view of the cell area showing another embodiment of the structure to fasten the translucent sheets forming said cell.

### DESCRIPTION OF THE PREFERRED EMBODIMENTS

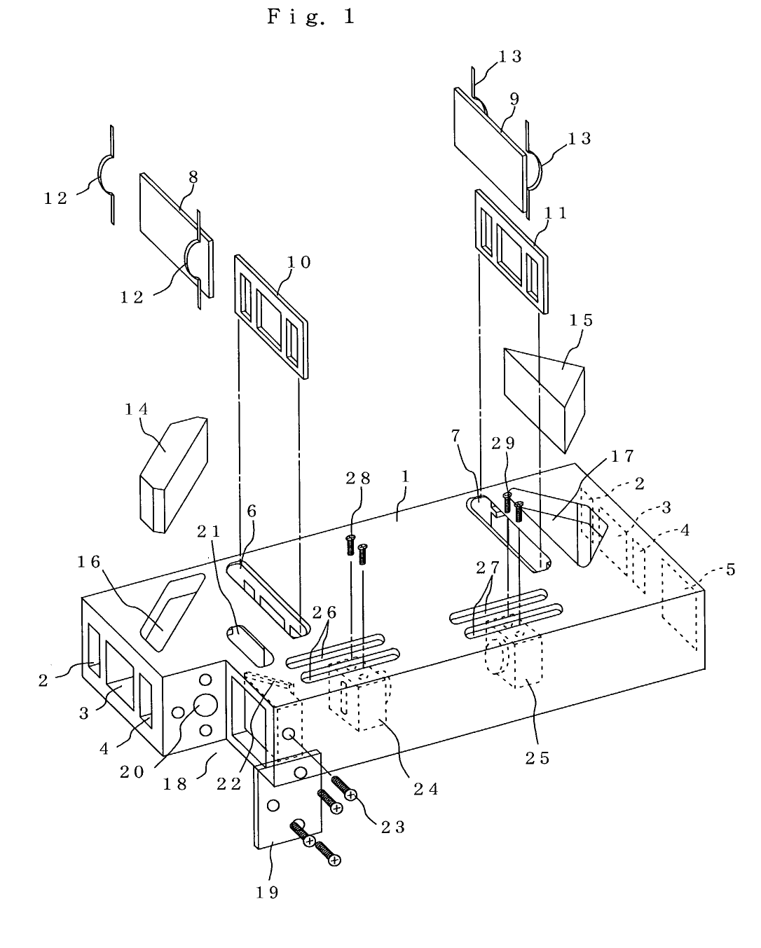

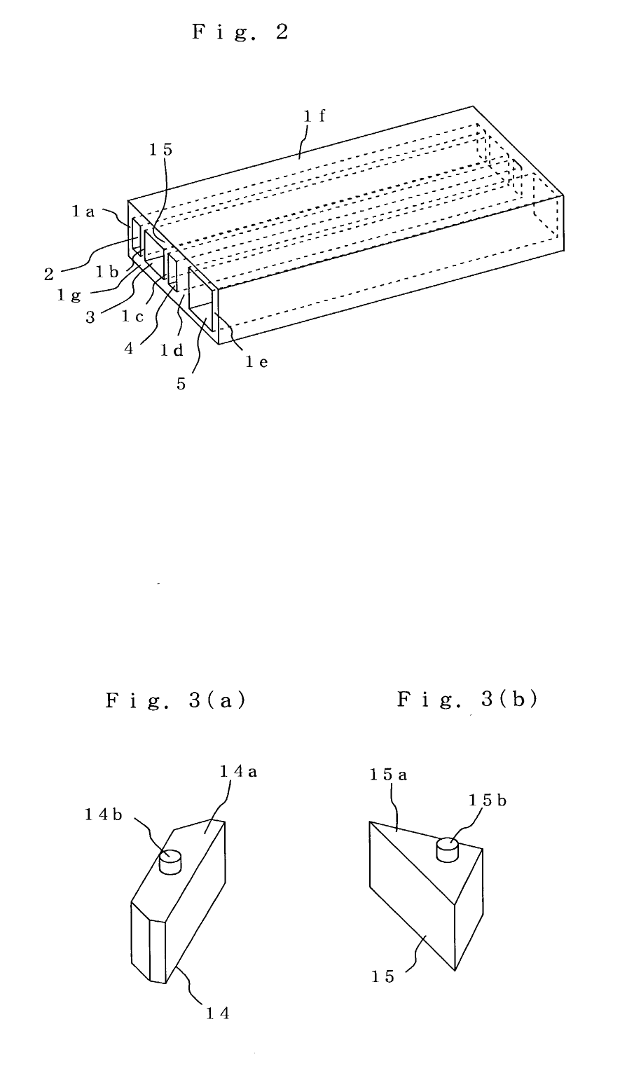

FIG. 1 shows an embodiment of a frame constituting a light-interference fluid characteristics analyzer according to this invention. A frame 1 is made of a base material such as aluminum or other metal having relatively higher rigidity and permitting easy drawing or extrusion. The frame has a first, second, third and fourth through-holes 2, 3, 4 and 5 as shown in FIG. 2.

The first and third through-holes 2 and 4 form reference cells S1 and S2, whereas the greater through-hole 3 in the middle forms a measuring cell M. Cavities 6 and 7 reaching from the top to the bottom of the frame are formed in given positions so as to hold opposing translucent sheets 8 and 9 that forms a light path of the length conforming to the gas to be analyzed. To insure air tightness from the frame 1, the translucent sheets 8 and 9 are pressed against opposite sides by sheet springs or other fastening means 12 and 13 through sealing materials 10 and 11 such as packing or grease layers.

Cavities 16 and 17 to hold a parallel plane mirror 14 constituting a beam splitter and a prism 15 are provided adjacent to and on the outside of the translucent sheets 8 and 9.

A portion of the area containing a fourth through-hole 5 is cut away and a through-hole 20 is pierced at 45 degrees to the parallel plane mirror 14 and a light-source element, such as a light-emitting diode or an incandescent lamp, is fitted in the through-hole 20 so as to face the parallel plane mirror 14.

A cavity 21 to pass the light reflected from the parallel plane mirror 14 is formed parallel to the light path connecting the optical element 19 and parallel plane mirror 14. A plane mirror 22 is fastened in an area where the cavity 21 and fourth through-hole 5 cross by a bolt or other fastening means 23. Lenses 24 and 25 to output an interference fringe at a given magnification at the exit end of the fourth through-hole 5 are disposed therein. The lenses 24 and 25 are movably fastened to parallel slits 26 and 27 formed in the fourth through-hole 5.

The cavities 6, 7, 16 and 17 to hold the optical elements and the slits 26 and 27 to fasten the lenses 24 and 25 can be formed precisely by electric-discharge machining or peripheral milling.

As the cavities 6, 7, 16 and 17 in the frame 1 are formed with high precision, the translucent sheets 8 and 9, parallel mirror 14 and prism 15 are precisely positioned by fastening in the cavities 6, 7, 16 and 17, respectively.

Final adjustment of interference fringe interval and size is done by changing the angle of the plane mirror 22 by loosening a fastening means 23 and adjusting the lenses 24 and 25 by loosening fastening means 28 and 29.

The parallel plane mirror 14 and prism 15 have projections 14b and 15b of the smallest possible cross-sectional area at the bottom thereof as shown in FIGS. 3(a) and 3(b). By fastening the parallel plane mirror 14 and prism 15 by forming an adhesive layer between the projections 14b and 15b and the frame 1, strain due to difference in thermal expansion coefficient between the frame 1 and the parallel plane mirror 14 and prism 15 can be reduced to a minimum.

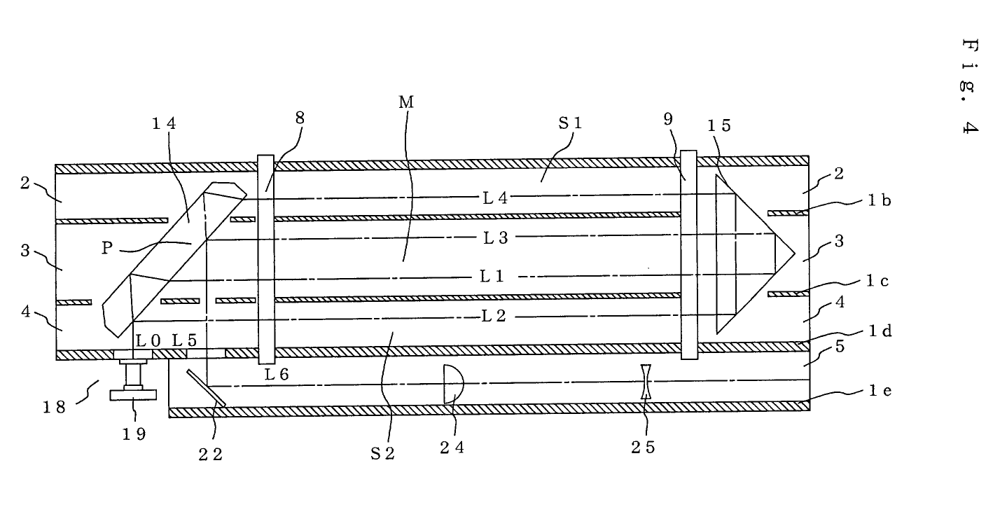

In the analyzer having the optical elements thus disposed, the parallel plane mirror 14 divides a parallel beam L0 from the light-source element 19 into two beams L1 and L2 as shown in FIG. 4. The beam L1 enters the prism 15 through a light path close to one side of the measuring cell M and then enters the parallel plane mirror 14 as a beam L3 passing through a light path close to the other side of the measuring cell M.

Another beam L2 passes through the reference cell S1 to the prism 15. A beam L4 emitted from the reference cell S2 forms an interference fringe together with the beam L3 at point P where the beam L3 from the measuring cell M1 is irradiated. Then, a beam L5 reaches the plane mirror 22. A magnifying optical system comprising the lenses 24 and 25 magnifies a beam L6 from the plane mirror 22 to a size suited for detection.

Comprising the vertical walls 1a to 1e defining the through-holes 2, 3, 4 and 5 and the top and bottom horizontal walls 1f and 1g, the frame 1 has high enough rigidity to insure light weight and reduce strain caused by external forces to a minimum. Furthermore, the translucent sheets 8 and 9 elastically pressed against the frame reduce to a minimum the strain of the translucent sheets 8 and 9 due to difference in thermal expansion coefficient between the translucent sheets 8 and 9 and the frame 1, thus permitting high-precision analysis by eliminating unnecessary movement of interference fringes.

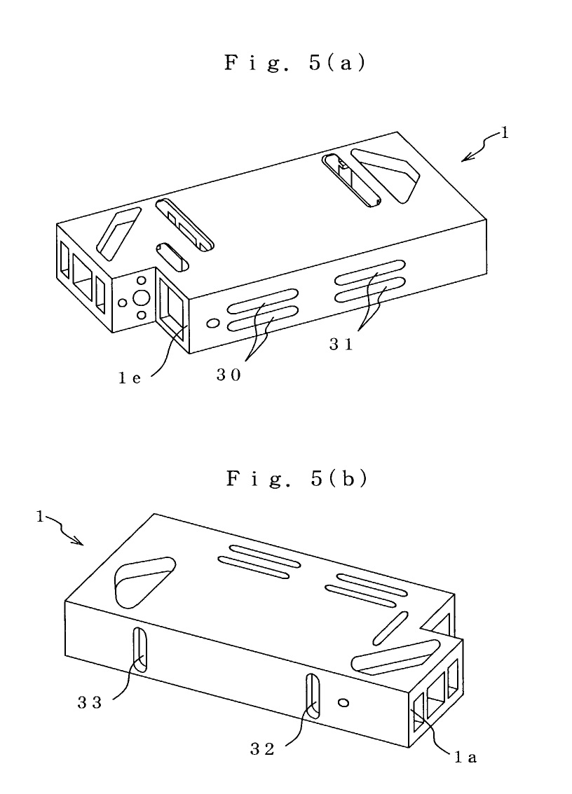

While the cavities are formed from the horizontal wall if of the frame 1 in the embodiment described, slits 30 and 31 to fasten the lenses may be formed in the vertical wall 1e as shown in FIG. 5(a) and through-holes 32 and 33 to accommodate the cell-forming translucent sheets 8 and 9 may be formed in the vertical walls 1a to 1e ass shown in FIG. 5(b).

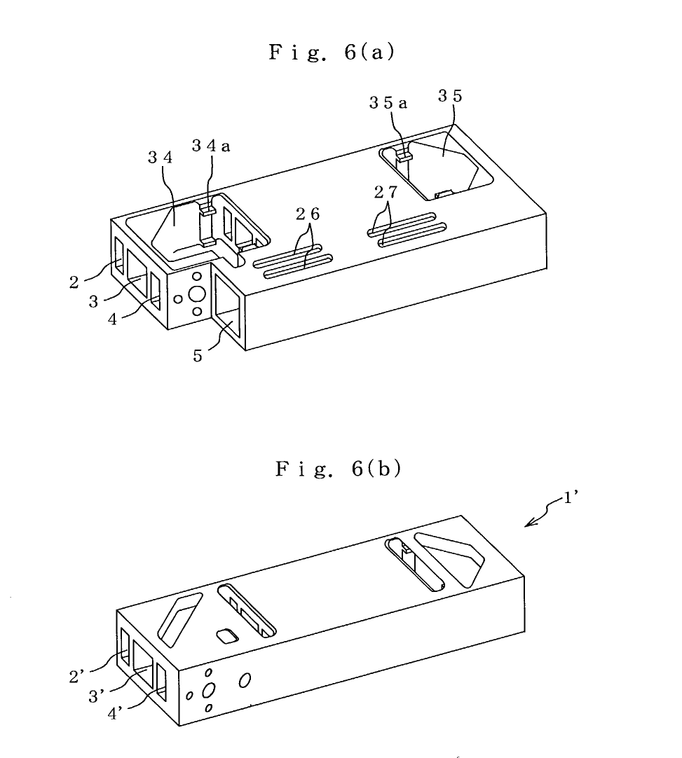

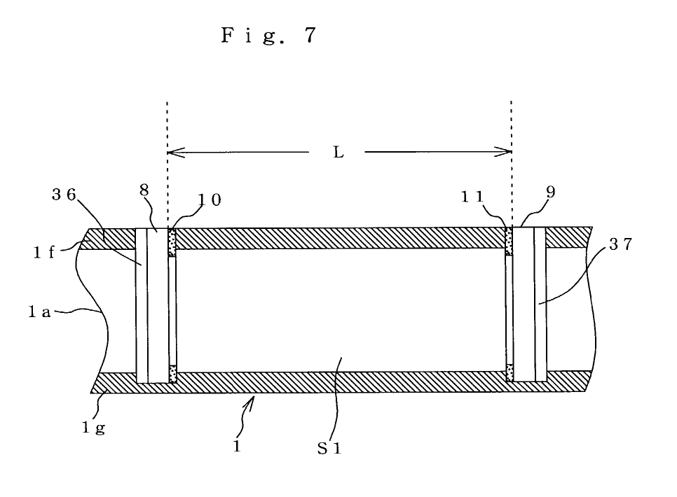

While the cavities 16 and 17 to accommodate the parallel plane mirror 14 and prism 15 and the cavities 6 and 7 to accommodate the cell-forming translucent sheets 8 and 9 are independently formed in the embodiment described, integral cavities 34 and 35 may be formed as shown in FIG. 6(a) that function similarly, in conjunction with partitions 34a and 35a that may be provided as required to define both sides of the translucent sheets 8 and 9.

While the through-holes in the embodiment described are rectangular in cross section, the through-holes may be of any shape offering no interference to the passage of beams, such as polygonal, circular or elliptical. The through-holes may also function similarly even if the outer cells S1 and S2 are filled with the fluid to be analyzed and the inner cell M with the reference fluid.

While the lenses 24 and 25 are fastened in the same frame 1 in the embodiment described, a frame 1′ having only through-holes 2′, 4′ and 3′ to form at least the reference cells S1 and S2 and the measuring cell M as shown in FIG. 6(b) may also achieve similar function and effect as a change in the light path of the beams converted into interference fringes has no effect on measuring accuracy.

While air-tightness in the embodiment described is insured by pressing the back of the translucent sheets 8 and 9 with sheet springs or other fastening means 12 and 13, the optical length of the cells can be defined with high precision by taking advantage of elasticity of the sealing materials 10 and 11 as shown in FIG. 7.

If the sealing members 10 and 11 are made of silicon rubber or other elastic material and the back of the translucent sheets 8 and 9 are pressed directly by the cavities 6 and 7 in the frame 1 or by spacers 36 and 37 of rigid material, the surface-to-surface distance between the translucent sheets can be kept constant regardless of elasticity of the sealing members 10 and 11. Besides, strain of the translucent sheets 8 and 9 due to difference in thermal expansion coefficient between the translucent sheets 8 and 9 and the frame 1 is eliminated. Furthermore, the use of the sealing members of elastic material provides greater sealing force than the fastening means 12 and 13 and thus prevents leakage from the cells more effectively.

What is claimed is:

1. A light-interference fluid characteristics analyzer comprising a frame made of a base having at least three through-holes in the same cross section and two cavities crossing said through-holes at a given distance, cells formed by sealing an area defined by said two opposing cavities with translucent sheets, and an optical element generating interference fringes by sending two beams from a single light source into said cell and reflecting the beams from said cell to a single spot through a prism.

2. A light-interference fluid characteristics analyzer according to claim 1, in which said cell is formed by inserting sealing members of elastic material and pressing the translucent sheets against said frame directly or by way of rigid members.

3. A frame for a light-interference fluid characteristics analyzer having at least through-holes in the same cross section, cavities crossing said through-holes at a given distance, and a cavity to accommodate an optical means to form interference fringes by sending two beams from a single light source into an area opposing said cavities.

4. A frame for a light-interference fluid characteristics analyzer according to claim 3, in which the cavities crossing said through-holes and the cavity to accommodate said optical means are formed integrally.
